(19) United States
(12) Patent Application Publication
(10) Pub. No.: US 2016/0077786 A1
(43) Pub. Date: Mar. 17, 2016

(54) ELECTRONIC DEVICE, METHOD AND STORAGE MEDIUM

(71) Applicant: Kabushiki Kaisha Toshiba, Tokyo (JP)

(72) Inventors: Shigeru Kizaki, Ome Tokyo (JP); Koji Hachiya, Akishima Tokyo (JP)

(21) Appl. No.: 14/950,561

(22) Filed: Nov. 24, 2015

Related U.S. Application Data
(63) Continuation of application No. PCT/JP2013/076115, filed on Sep. 26, 2013.

(51) Int. Cl. G06F 3/14; G06F 3/01

(52) U.S. Cl. CPC G06F 3/1423; G06F 3/01

(57) ABSTRACT

According to one embodiment, an electronic device includes multiple terminals and a hardware processor. Each of the terminals is connectable to a display device. The hardware processor is configured to detect, if a first display device is connected to one of the terminals, a connection of a second display device to another of the terminals, and inform a user of the connection of the second display device.

### CROSS REFERENCE TO RELATED APPLICATIONS

This application is a Continuation Application of PCT Application No. PCT/JP2013/076115, filed Sep. 26, 2013, the entire contents of which are incorporated herein by reference.

### FIELD

Embodiments described herein relate generally to an electronic device connectible with a plurality of display devices.

### BACKGROUND

A conventional electronic device such as a notebook PC includes a monitor terminal to which an external display device can be connected, and is capable of displaying an image formed by the notebook PC, on an external display device including a screen larger than a screen of the notebook PC. Various types of monitor terminals for external display devices, such as RGB (also called VGA (Video Graphics Array) or analog), DVI (Digital Visual Interface), and display port, have been developed. A notebook PC includes plural types of monitor terminals. The number of digital ports of a graphics controller by which image data is output to an external display device is limited. Not all the monitor terminals can be supported. The image data output from the digital port is supplied to any one of monitor terminals via a selector. In other words, the image is displayed on an external display device connected to any one of the monitor terminals.

If the notebook PC includes two types of monitor terminals, the notebook PC further includes a sliding shutter on two monitor terminals. Either of the monitor terminals is shielded by the shutter such that a monitor cable cannot be connected to the monitor terminal. The selector is switched in cooperation with the sliding operation of the shutter. If the shutters are not mounted on the two monitor terminals, two types of external display devices different in monitor cable may be simultaneously connected to the two monitor terminals but an image is not displayed on either of the external display devices. Thereby, the shutters prevent undesirable situations.

However, if the notebook PC includes at least three types of monitor terminals, a mechanical shutter for exposing any one of the monitor terminals and shielding two remaining monitor terminals can hardly be implemented. For this reason, during display of an image on an external display device connected to any one of the monitor terminals, a monitor cable of the other external display device may be connected to the other one of monitor terminals. In this case, since the image is not displayed on the other external display device but a warning or a notice is not supplied to the user, the user cannot understand the reason why the image is not displayed although the user connects the external display device to the monitor terminal.

Recently, performance of a graphics processor is enhanced and plural external display devices can be simultaneously connected to a PC. A plurality of, for example, two digital ports for external display devices are provided on the graphics processor besides a port for an internal display device, and each of the two digital ports is connected to any one of the monitor terminals via the selector. In other words, plural monitor terminals are grouped for each digital port. Plural external display devices can be connected to the plural monitor terminals in several groups but an image can be displayed on only one external display device in the same group. In this case, the user may connect plural external display devices with monitor terminals of the same group at high probability. The situation in which the image is not displayed although the external display device is connected to the monitor terminal may easily occur as explained above, and the user may be confused.

The conventional electronic device does not notify the user of this situation when plural external display devices are connectible and they are connected regardless of specifications.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of a configuration of a PC as an electronic device according to an embodiment.

FIG. 2 is an illustration showing an example of output terminals to which an external display device of the embodiment is connected.

FIG. 3 is a block diagram showing an example of a system configuration of the PC.

FIG. 4 is a diagram showing an example of a relationship among an embedded controller, BIOS, and a monitor terminal connection check application.

FIG. 5 is a flowchart showing an example of operations of the embodiment.

FIG. 6 is an illustration showing an example of a popup displayed on an external display device when a check result is abnormal.

FIG. 7 is an illustration showing an example of a warning message displayed on an external display device when a check result is abnormal.

### DETAILED DESCRIPTION

Various embodiments will be described hereinafter with reference to the accompanying drawings.

In general, according to one embodiment, an electronic device includes multiple terminals and a hardware processor. Each of the terminals is connectable to a display device. The hardware processor is configured to detect, if a first display device is connected to one of the terminals, a connection of a second display device to another of the terminals; and inform a user of the connection of the second display device.

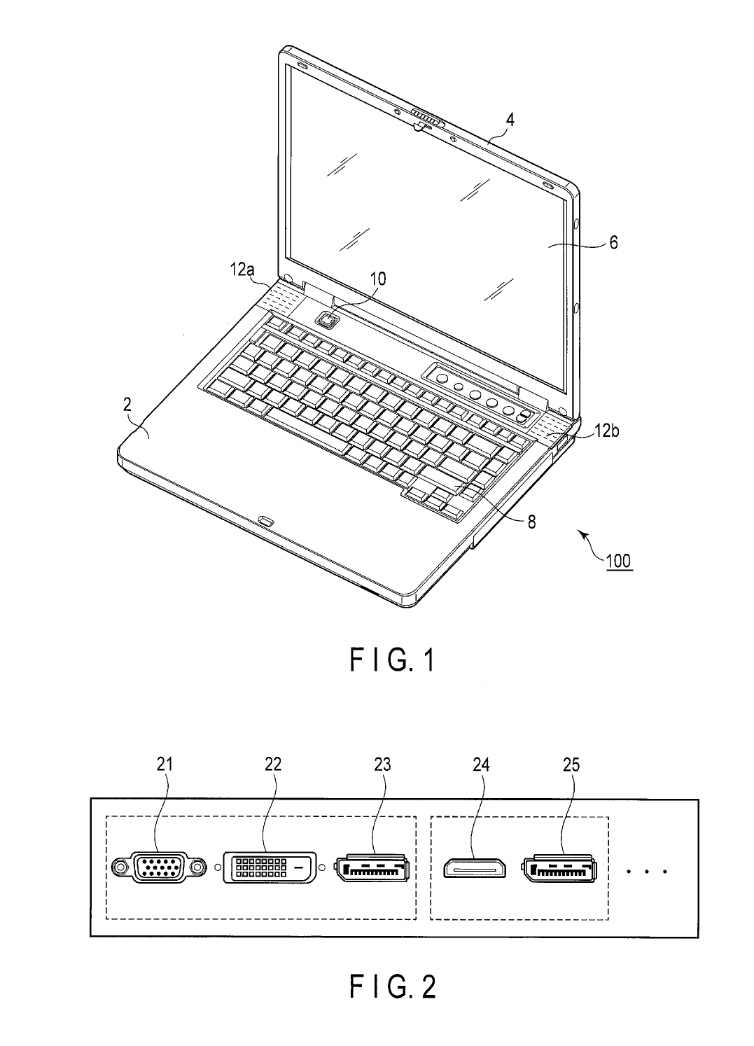

FIG. 1 is a perspective view showing an appearance of an electronic device of a first embodiment. The electronic device is implemented as, for example, a notebook-type personal computer 100. The computer 100 includes a computer body 2 and a display unit 4. A liquid crystal display (LCD) 6 is built in the display unit 4.

The display unit 4 is attached to the computer body 2 so as to be rotatable between an opened position at which a top surface of the computer body 2 is exposed and a closed position at which the top surface of the computer body 2 is covered.

The computer body 2 includes a housing shaped in a flat box and, on the top surface thereof, a keyboard 8, a power switch 10 to turn on/off the power of the computer 100, speakers 12a and 12b, etc. are arranged. Various terminals are provided on a back surface of the computer body 2. The various terminals include a headphone output terminal, a USB terminal, a microphone input terminal, a LAN terminal, and an output terminal (also called a monitor terminal) group to which a monitor cable of an external display device is connected. An example of the output terminal group is shown in FIG. 2. The output terminal group is classified into two groups, i.e., group A and group B. Frames indicating the group classification are shown on the back surface. The group A includes an RGB terminal 21, a DVI terminal 22 and a display port terminal (or mini-display port terminal) 23 and the group B includes an HDMI terminal 24 and a display port terminal (or mini-display port terminal) 25. The number and type of the monitor terminals in each group are not limited to these, but can be arbitrarily selected, and the number of groups is not limited to two, but may be at least three. The number of groups is determined depending on the number of digital ports of a graphics controller to be explained later.

The computer 100 is activated by turning on the power switch 10 by the user. The activated computer 100 is operated in accordance with an input signal from an input interface such as the keyboard 8 by the user operation. The computer 100 displays information on the LCD 6 in accordance with the input signal.

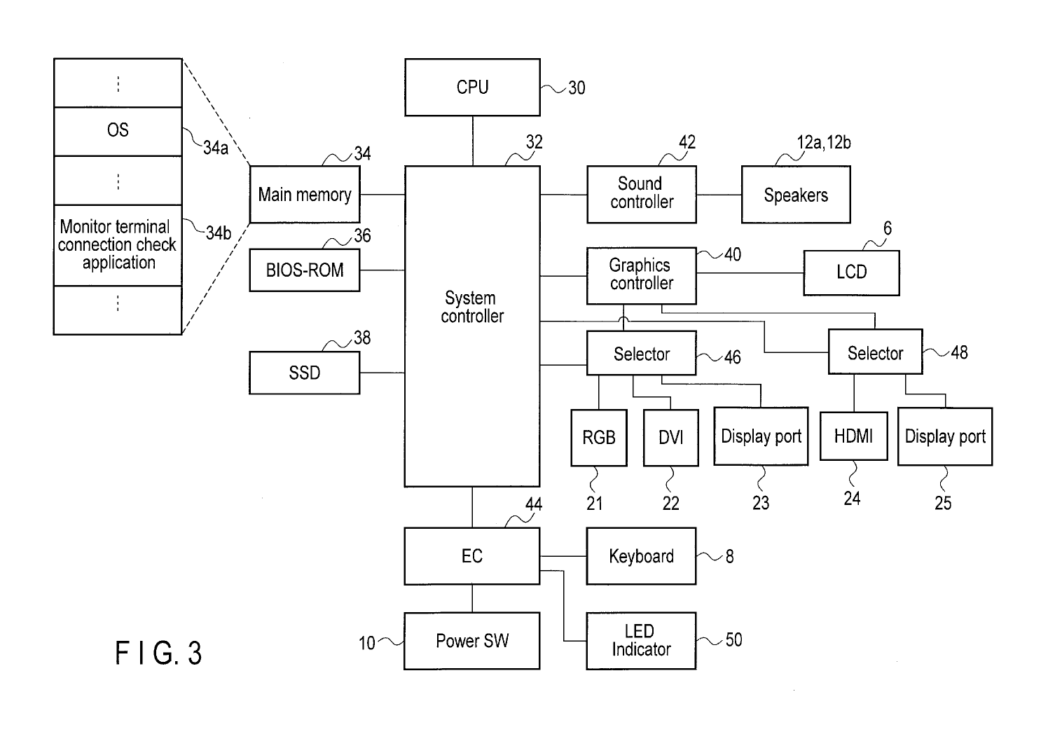

FIG. 3 shows a system configuration of the computer 100. The computer 100 includes a CPU 30, a system controller 32, a main memory 34, a BIOS-ROM 36, a nonvolatile storage, such as hard disk drive (HDD) or a solid-state drive (SSD) 38, a graphics controller 40, a sound controller 42, an embedded controller (EC) 44, etc.

The CPU 30 is a hardware processor for controlling operations of various components in the computer 100. The CPU 30 executes various types of software loaded from the SSD 38, which is a nonvolatile semiconductor storage device, on the main memory 34. The software includes an operating system (OS) 34a, a monitor terminal connection check application program 34b, etc. The monitor terminal connection check application program 34b monitors a status of connection of the monitor cable to the monitor terminal group and, if the status is a connection status out of specifications, supplies a warning or a notice to the user.

The CPU 30 also executes a Basic Input/Output System (BIOS) stored in the BIOS-ROM 36. The BIOS is a program for hardware control.

The system controller 32 is a device which makes connection between the CPU 30 and various components. A memory controller which controls access to the main memory 34 is built in the system controller 32. The CPU 30, the main memory 34, the BIOS-ROM 36, the SSD 38, the graphics controller 40, the sound controller 42, the embedded controller 44, etc., are connected to the system controller 32.

The graphics controller 40 controls the LCD 6 employed as a display monitor of the personal computer 100. The graphics controller 40 transmits a display signal to the LCD 6 under control of the CPU 30. The LCD 6 displays a screen image, based on the display signal. The graphics controller 40 can also supply a warning/notice message produced by the monitor terminal connection check application program 34b to the LCD 6. The graphics controller 40 includes two ports (second and third digital ports) for the external display device besides a port (first digital port) for supplying a display signal to the LCD 6 (an internal display device). These three ports may output the same display signal or different display signals. In addition, signals may not only be displayed simultaneously on the internal/external display devices, but may also be displayed on either the internal display device or the external display device. The second digital port is connected to the monitor terminals of the group A, i.e., the RGB terminal 21, the DVI terminal 22 and the display port terminal 23, via a selector 46. The third digital port is connected to the monitor terminals of the group B, i.e., the HDMI terminal 24 and the display port terminal 25, via a selector 48. Switching the selectors 46 and 48 is controlled by the system controller 32.

The sound controller 42 is a controller for processing a speech signal, and controls speech output from the speakers 12a and 12b. The sound controller 42 can also generate an alarm such as a beep produced by the monitor terminal connection check application program 34b.

The embedded controller 44 is a single-chip microcomputer including a controller for power management. The embedded controller 44 has a function of turning on and off the power of the computer 100 in accordance with a user's operation on the power switch 10. In addition, the embedded controller 44 controls input of the keyboard 8. An LED indicator 50 capable of displaying a monitor connection check result besides various statuses is also provided on the upper surface of the computer body 2 though not shown in FIG. 1. The indicator 50 is connected to the embedded controller 44.

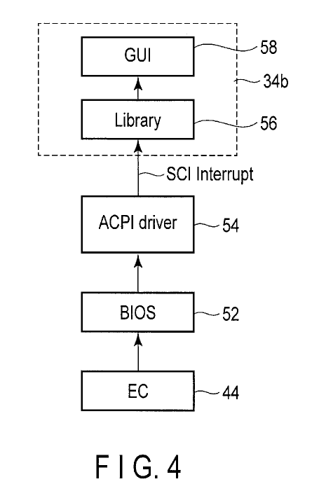

FIG. 4 is a diagram showing a relationship among the monitor terminal connection check application program 34b, the embedded controller 44 and BIOS 52. Connection of an external display device to the monitor terminal is detected by the embedded controller 44. The embedded controller 44 notifies the BIOS 52 that the connection has been detected. The BIOS 52 notifies an Advance Configuration and Power Interface (ACPI) driver 54 of the connection event and the external connection monitor information (i.e., type of the monitor terminal having the connection detected). The ACPI driver 54 supplies the external connection monitor information and a system control interrupt (SCI) to the monitor terminal connection check application program 34b. If the monitor terminal connection check application program 34b receives the SCI interrupt, the monitor terminal connection check application program 34b creates a GUI 58 for a predetermined warning message based on external connection monitor information, by a library 56, and supplies the GUI 58 to the graphics controller 40.

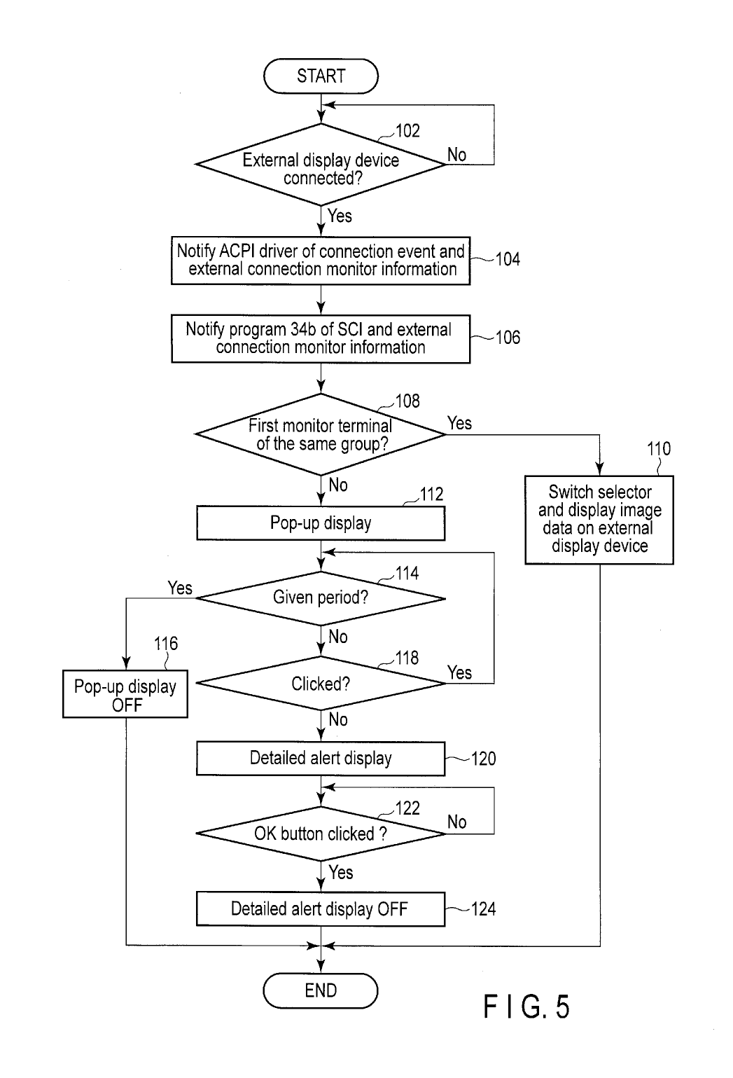

FIG. 5 is a flowchart showing an example of the operations of the embodiment.

In block 102, the embedded controller 44 determines whether the monitor cable of the external display device is connected to any one of the monitor terminals or not. If the connection of the monitor cable to any one of the monitor terminals is detected, the embedded controller 44 notifies the BIOS 52 that the connection has been detected, and the BIOS 52 notifies the ACPI driver 54 of the connection event, and the external connection monitor information (identification of the monitor terminal having the connection detected, i.e., number of the terminal of the group A, etc.) and the type thereof (HDMI, etc.) in block 104. In block 106, the ACPI driver 54 notifies the monitor terminal connection check application program 34b of the external connection monitor information and the system control interrupt (SCI).

If the monitor terminal connection check application program 34b receives the SCI interrupt, the monitor terminal connection check application program 34b determines whether the monitor terminal having the connection detected is the first terminal of the monitor terminals in the same group or not, based on the external connection monitor information, in block 108. If the monitor terminal is the first terminal in the same group, the monitor terminal connection check application program 34b controls the graphics controller 40 and the selector 46 or 48 via the system controller 32 to allow the image data output from the digital port of the group of the graphics controller 40 to be supplied to the external display device connected via the monitor terminal and displayed, in block 110.

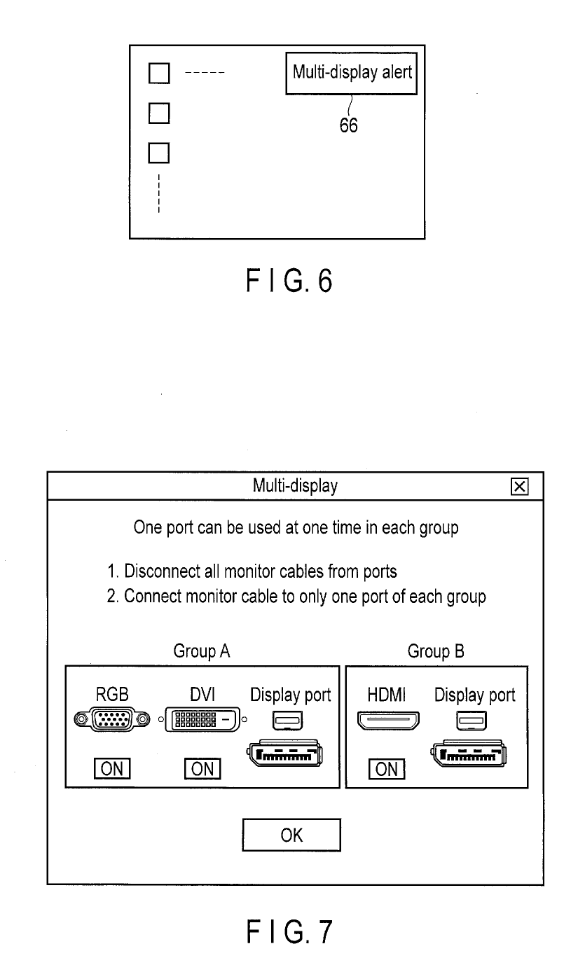

If the monitor terminal having the connection detected is not the first terminal in the same group, i.e., if the monitor cable has been already connected to any one of the terminals in the same group, the monitor terminal connection check application program 34b allows the library 56 to create a GUI 58 for a pop-up 66 indicating an error in multi-display as shown in FIG. 6 (in this case, connection of at least one monitor cable in the group) and supplies the GUI 58 to the graphics controller 40, in block 112. The graphics controller 40 displays the GUI 58 on the first connected external display device not the second connected external display device or the following external display device in each group. For this reason, the selector 46 or 48 cannot be switched as it is in the status set in block 110. The pop-up 66 is a small window displayed for a given period while the application screen or the desktop screen (in the case of FIG. 6) is displayed.

The monitor terminal connection check application program 34b determines whether a given period has elapsed after start of the pop-up display or not, in block 114. If a given period has elapsed, the monitor terminal connection check application program 34b turns off the pop-up display in block 116.

In block 118, the monitor terminal connection check application program 34b determines whether the pop-up 66 has been clicked or not prior to the lapse of a given period. If clicking is not detected, the processing returns to block 114.

With the pop-up display alone, users having knowledge of PC can recognize a connection error and understand that all monitor cables may be disconnected and the monitor cable may be connected again as the connection conforming to the specifications. In this case, users do not need to execute anything (clicking) during the pop-up display, and may await the pop-up display to disappear automatically after a given period has elapsed. Conversely, users not having knowledge of PC may click the pop-up display.

If clicking is detected in block 118, the monitor terminal connection check application program 34b turns off the pop-up display, allows a GUI for detailed alert as shown in FIG. 7 to be generated instead, supplies the detailed GUI to the graphics controller 40, and allows the detailed GUI to be displayed on the first connected external display device in each group, similarly to the pop-up 66, in block 120. Nothing is displayed on the second connected external display device and the following external display devices in each group.

An example of the detailed alert includes the connection status of specifications regarding the multi-display and the text indicating a solution method for returning to the status of specifications, as shown in FIG. 7. The connection status of specifications is “One port is used at one time in each group” and a solution method is “1. Disconnect all monitor cables from port. 2. Connect monitor cable to one port of each group”.

An image of the monitor terminals on the back of the computer body 2 and ON marks indicating that the monitor cables are currently connected may be displayed at a lower portion of the text. It can be understood in the example of FIG. 7 that the cables are connected to two monitor terminals (RGB and DVI) of group A and the connection of group A is out of specifications. For this reason, it can also be understood that not all monitor cables, but the monitor cables of group A alone may be removed from the ports. By thus disconnecting all monitor cables from the ports and connecting a monitor cable to only one port of each group, the monitor terminal connection check application program 34b returns to the status of block 110 and the image data can be displayed on the first connected external display device in each group. The detailed alert display can be turned off by clicking the OK button.

For this reason, the monitor terminal connection check application program 34b determines whether the OK button has been clicked or not, in block 122. If clicking is detected, the detailed alert display is turned off in block 124.

The operations end after execution of block 124, 116 or 110.

According to the first embodiment, as explained above, if an external display device becomes incapable of displaying since the user makes connection out of specifications to PC to which a plurality of external display devices can be connected, an alarm is displayed on the external display device capable of displaying and the user is notified of the alarm display. For this reason, the user immediately understands the reason why the image cannot be displayed on the external display device which is connected by the user who believes that the display device is usable. Furthermore, since the user can be notified of the solution method of returning the status to a connection status of specifications, the user can easily return from the status to the normal status without reading a manual.

In the embodiment, the graphics controller includes two external output ports and the monitor terminals are classified into two groups, but the graphics controller may include one external output port. In this case, the monitor terminals are not classified into a plurality of groups.

In the embodiment, the user's knowledge of PC is assumed at two levels, and message is displayed by two steps, i.e., the pop-up display for users having knowledge and the detailed alert display for beginners are prepared. However, the user may preliminarily select any one of the displays or the displays of two levels, by the settings of PC.

In the embodiment, the alarm message is displayed on the screen of the external display device. However, instead of this or in addition to this, the alarm message may be displayed on the built-in LCD 6. Furthermore, the alarm is displayed as the message. However, instead of this or in addition to this, the alarm message may be output as speech from the speakers 12a and 12b by using the speech synthesis. Furthermore, the user may be notified of the alarm as light by the LED indicator 50.

Since the monitor terminal connection check application program 34b recognizes the monitor terminal to which the monitor cable is connected, based on the external connection monitor information, the monitor terminal connection check application program 34b can recognize which group is out of specifications. For this reason, instead of a message for disconnecting all the monitor cables in all groups shown in FIG. 7, a message for disconnecting all monitor cables in a specific group may be displayed.

All the monitor cables are disconnected for return from the connection status out of specifications to the status conforming to specifications. However, the flowchart of FIG. 5 may be executed from the beginning by disconnecting monitor cables other than the external display device which is to be usable and resetting the statuses of the selectors 46 and 48. In other words, if block 102 is executed in a state in which only one monitor cable is connected in each group, the image data is displayed on the monitor terminal alone to which the monitor cable is connected, and the image is displayed on the external display device alone.

The embodiment relates to the notebook-type PC, but is not limited to this and may relate to a tablet-type PC, a game console, a portable digital device or the like. In addition, an example of directly providing a plurality of monitor terminals on the electronic device is explained. However, if the monitor terminals are not provided on the electronic device, but on a function expansion dock, etc., and the function expansion dock is connected to the external display device, the electronic device may be connected to the function expansion dock.

Since the processing of the present embodiment can be implemented by the computer program, advantages similar to the advantages of the present embodiment can easily be obtained by merely installing the computer program in a computer via a computer-readable storage medium in which the computer program is stored and by merely executing the computer program.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

What is claimed is:

1. An electronic device comprising:
multiple terminals each of which is connectable to a display device; and
a hardware processor configured to:
detect, if a first display device is connected to one of the terminals, a connection of a second display device to another of the terminals; and
inform a user of the connection of the second display device.

2. The electronic device of claim 1, wherein
the terminals comprise a first group of terminals and a second group of terminals; and
the hardware processor is configured to detect, if the first display device is connected to one terminal of the first or second group of terminals, a connection of the second display device to another terminal of the same group of terminals.

3. The electronic device of claim 1, wherein
the hardware processor is configured to display a message indicative of the connection of the second display device on the first display device.

4. The electronic device of claim 3, wherein
the hardware processor is configured to display a pop-up window indicative of connections of plural display devices to plural terminals on the first display device; and
display a second message indicative of recover steps if the pop-up window is clicked.

5. The electronic device of claim 4, wherein
the hardware processor is configured to
display the pop-up window for a given period of time; and
display the second message until a predetermined portion in the second message is clicked.

6. The electronic device of claim 1, wherein
the hardware processor is configured to generate a sound indicative of the connection of the second display device.

7. The electronic device of claim 1, wherein
the hardware processor is configured to generate a light indicative of the connection of the second display device.

8. A method comprising:
detecting, if a first display device is connected to one of multiple terminals, a connection of a second display device to another of the terminals; and
informing a user of the connection of the second display device.

9. The method of claim 8, wherein
the terminals comprise a first group of terminals and a second group of terminals; and
the detecting comprises detecting, if the first display device is connected to one terminal of the first or second group of terminals, a connection of the second display device to another terminal of the same group of terminals.

10. The method of claim 8, comprising:
displaying a message indicative of the connection of the second display device on the first display device.

11. The method of claim 10, comprising:
displaying a pop-up window indicative of connections of plural display devices to plural terminals on the first display device; and
displaying a second message indicative of recover steps if the pop-up window is clicked.

12. The method of claim 11, comprising:
displaying the pop-up window for a given period of time; and
displaying the second message until a predetermined portion in the second message is clicked.

13. A non-transitory computer-readable storage medium storing a computer program which is executable by a computer, the computer program controlling the computer to execute functions of:
detecting, if a first display device is connected to one of multiple, a connection of a second display device to another of the terminals; and
informing a user of the connection of the second display device.

14. The storage medium of claim 13, wherein
the terminals comprise a first group of terminals and a second group of terminals; and
the detecting comprises detecting, if the first display device is connected to one terminal of the first or second group of terminals, connection of the second display device to another terminal of the same group of terminals.

15. The storage medium of claim 13, comprising:
displaying a message indicative of the connection of the second display device on the first display device.

16. The storage medium of claim 15, comprising:
displaying a pop-up window indicative of connections of plural display devices to plural terminals on the first display device; and
displaying a second message indicative of recover steps if the pop-up window is clicked.

17. The storage medium of claim 16, comprising:
displaying the pop-up window for a given period of time; and
displaying the second message until a predetermined portion in the second message is clicked.
